(19) United States
(12) Patent Application Publication
(10) Pub. No.: US 2010/0122757 A1
(43) Pub. Date: May 20, 2010

(54) TIRE AND ELECTRONIC DEVICE ASSEMBLY

(76) Inventors: Robert Edward Lionetti, Bereldange (LU); Jean-Claude Alie, Bagstogne (BE); Gary Edwin Tubb, Copiey, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/272,881

(22) Filed: Nov. 18, 2008

(51) Int. Cl. B60C 19/08

(52) U.S. Cl. 152/152.1

(57) ABSTRACT

A tire and electronic device assembly includes an electronic device in which a transponder tag is coupled to a dipole antenna formed by first and second elongate antenna segments. The transponder tag and at least a portion of the dipole antenna are at least partially embedded within a compound having compatible permittivity and conductivity with operation of the dipole antenna and the electronic device is mounted to the tire apex in a position between the tire apex and the tire sidewall at a predetermined distance above an ending of the tire ply and in an orientation placing a longitudinal axis of the dipole antenna perpendicular to the cords of the tire ply.

### FIELD OF THE INVENTION

The invention relates generally to the incorporation of an electronic device in a tire and, more specifically, to a tire having an embedded radio frequency identification tag.

### BACKGROUND OF THE INVENTION

Incorporation of an RFID tag into a tire can occur during tire construction and before vulcanization or in a post-cure procedure. Such tags have utility in transmitting tire-specific identification data to an external reader. UHF (ultra-high frequency) tags are typically small and utilize flexible antennas for the transmission of data. When embedded into a tire, such as during tire construction, the device represents a foreign object that can affect the structural integrity of the tire. UHF RFID tags, therefore, not only do not serve to reinforce the tire structure but may, in fact, act to degrade the tire in the embedded tag region.

Many locations within a tire are not suitable for placing an RFID tag because of cyclical flexural bending in service or because the location does not permit suitable radio frequency compatibility for reading applications. Accordingly, there remains a need for a tire having a UHF RFID tag embedded therein in a manner that does not degrade the performance or durability of the tire, is mechanically suitable and durable in service, provides suitable radio frequency reading capability, and is capable of efficient incorporation into the tire manufacturing process.

### SUMMARY OF THE INVENTION

According to an aspect of the invention, a tire and electronic device assembly is provided. The tire is constructed having a pair of beads, at least one ply layer having a plurality of parallel cords extending from one bead to an opposite bead and a ply ending wrapped around the one bead. The tire further includes an outer sidewall, an apex component positioned above the one bead and extending upward to an apex component end, and a chafer component wrapped around the one bead and extending upward to a chafer component end. The assembly includes an electronic device in which a transponder tag is coupled to a dipole antenna formed by first and second elongate antenna segments.

Pursuant to a further aspect of the invention, the transponder tag and at least a portion of the dipole antenna is at least partially embedded within a compound having compatible permittivity and conductivity with operation of the dipole antenna.

In another aspect, the electronic device is mounted to the tire apex in a position between the tire apex and the tire sidewall at a predetermined distance above an ending of the tire ply and in an orientation placing a longitudinal axis of the dipole antenna perpendicular to the cords of the tire ply. The electronic device may further be positioned between the tire chafer ending and the tire apex ending and above an ending of the tire ply a distance of at least 10 mm.

### DEFINITIONS

“Aspect ratio” of the tire means the ratio of its section height (SH) to its section width (SW) multiplied by 100% for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Camber angle” means the angular tilt of the front wheels of a vehicle. Outwards at the top from perpendicular is positive camber; inwards at the top is negative camber.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are substantially reduced depth as compared to wide circumferential grooves which the interconnect, they are regarded as forming “tie bars” tending to maintain a rib-like character in tread region involved.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Slip angle” means the angle of deviation between the plane of rotation and the direction of travel of a tire.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a side elevational view of the electronic device;

FIG. 2 is a top plan view of the electronic device showing in phantom the coverage area of a compound spray;

FIG. 3 is a perspective view of the electronic device;

FIG. 4 is a top perspective view of the electronic device;

FIG. 5 is a top perspective view of the electronic device shown in the process of receiving a selective compound coating;

FIG. 6 is a top perspective view of the coated electronic device shown subsequent to the coating operation of FIG. 5;

FIG. 7A is a sectional perspective view of a partial tire having an electronic device mounted in a sidewall location;

FIG. 7B is a sectional perspective view of a partial tire having an electronic device mounted at an alternative position;

FIG. 8 is a cross sectional view of a tire having an electronic device mounted thereto;

FIG. 9A is a section view of the electronic device shown in FIG. 7A; and

FIG. 9B is a section view of the electronic device shown in FIG. 7-B.

### DETAILED DESCRIPTION OF THE INVENTION

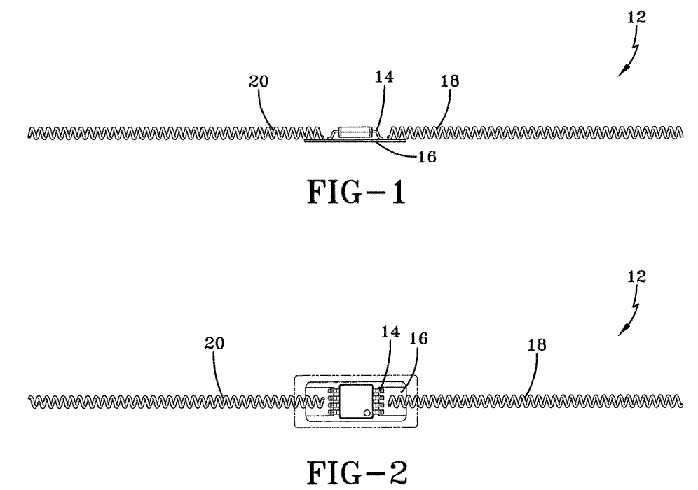

With initial reference to the exemplary embodiment shown in FIGS. 1,2, 3, and 4, an electronic device 10 is shown to include a RFID transponder tag 12 having interface contacts 14 mounted to a substrate 16. The RFID transponder tag 12 is of a type providing for the electronic memory storage of data and the communication of such data to an external reader (not shown). The transponder tag 12 may utilize UHF frequencies in the transmission of the data to the external reader. Coupled to the transponder tag 12 is a dipole antenna formed by two elongate antennas 18, 20 connected by suitable means such as welding to the contacts 14. The antennas 18, 20 are preferably but not necessary formed as elongate coils. The term “antenna” as used herein refers to any suitable antenna configuration functional for the intended application including, but not limited to, the dipole antenna formed by the antenna segments 18, 20.

The device 10 is intended to be embedded within a tire as will be explained, preferably although not necessarily during tire construction and before vulcanization. Although the size of the device 10 is relatively small and the antenna 18, 20 is flexible, the device 10 nonetheless represents a foreign object within a host tire. As with any foreign object, the device 10 therefore does not reinforce the tire structure but rather represents a structural anomaly that may impact the performance of the tire. Conversely, the environment of a tire in use may be harmful or inhospitable to the survival and performance of the device 12. Thus, for the intended purpose of the invention, maintaining the structural of a host tire and the electronic device in a manner that will allow the transponder/tag to transmit information as necessary is desired.

The subject tire and electronic device assembly 10 locates and orients the device 12 into a tire in a manner that does not degrade the performance or durability of the tire; is mechanically suitable for tag durability in service; and provides a suitable radio frequency compatible environment for sundry reading applications. In addition, the assembly 10 may be created seamlessly and at an efficient relatively low cost in the tire manufacturing process.

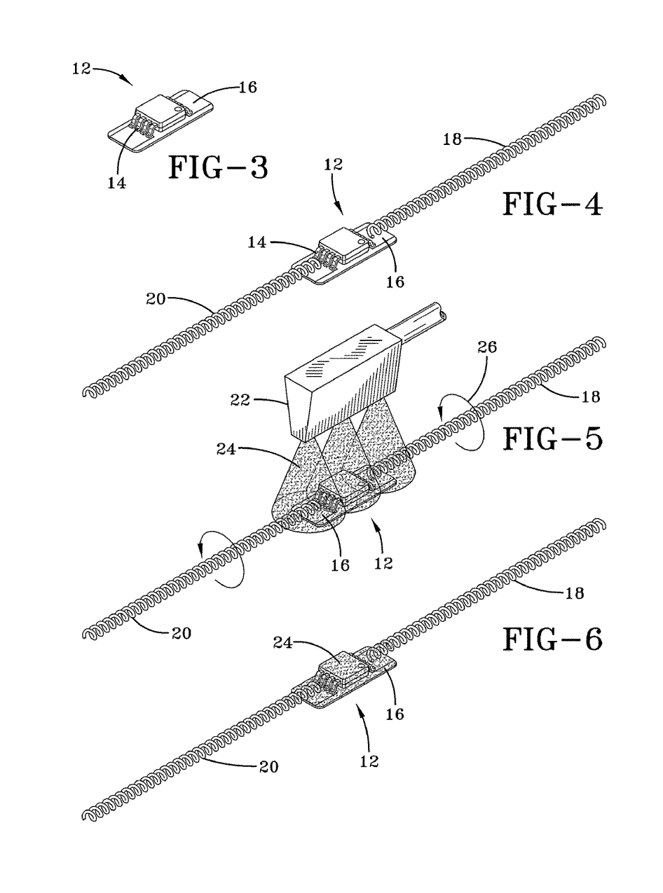

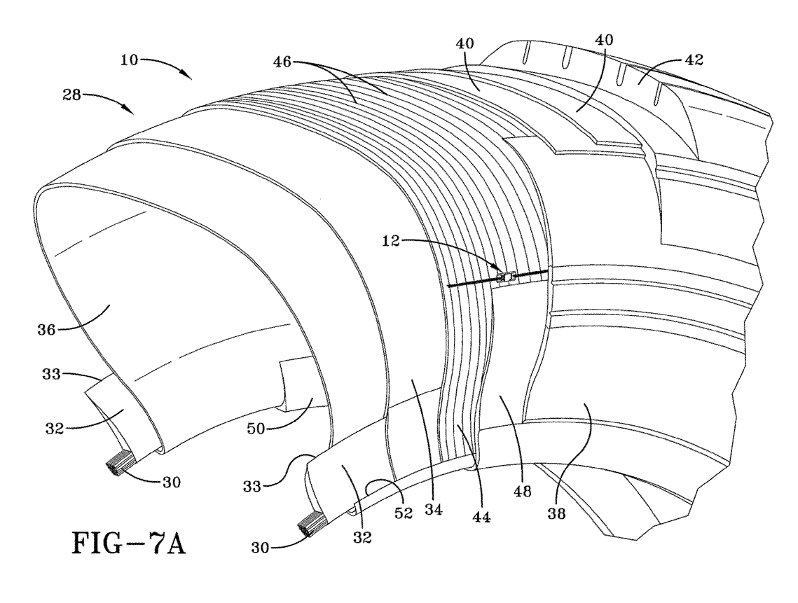

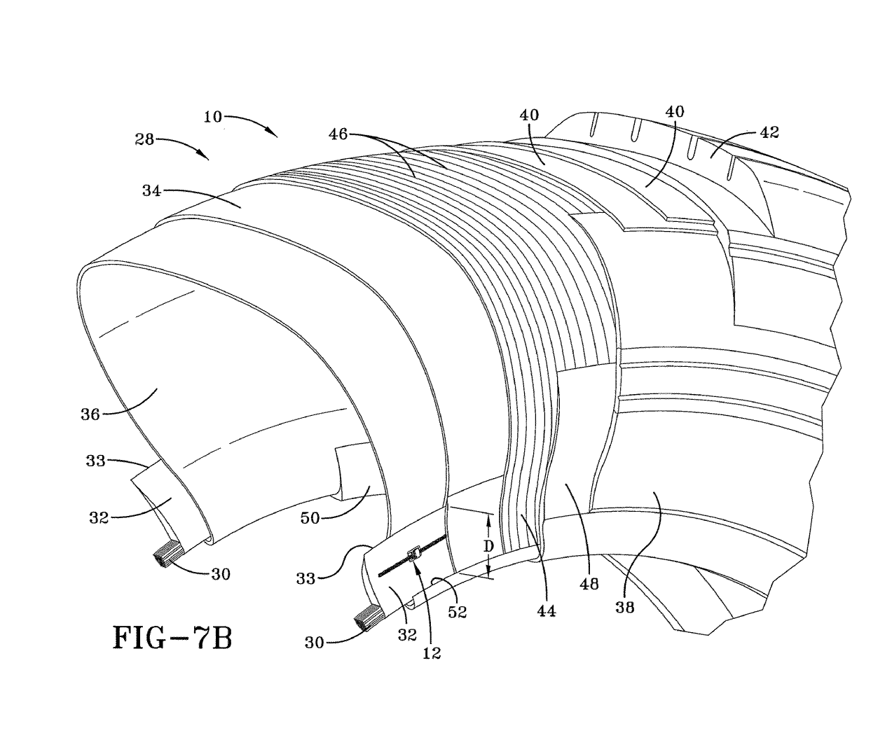

As shown in FIGS. 1-6, the electronic device 12 is embedded by an applicator 22 in a suitable compound 24 that has compatible permittivity and conductivity to not interfere with the antenna performance. In addition to the radio frequency compatibility, the compound 24 preferably will have physical properties that are suitable in the environment of surrounding tire components. The compound 24 preferably will provide smooth transition from the rigid electronic device 12 and antenna 18, 20 to the neighboring tire components. For example, the material stiffness and hysterisis must not create unwanted stress concentration or heat build up to not impact the tire performance. The encapsulating compound must also have suitable adhesion to surrounding tire components and to the components of the tag assembly 10. Material 24 meeting the above criteria is commercially available.

The material 24 encapsulates selective portions of the electronic device 12 as shown. Preferably, the compound 24 by a rotation of the electronic device 12 in the shown direction 26 will encapsulate the RFID device 12, contacts 14, and the substrate 16 as well as at least the portions of antenna coils 18, 20 that connect to the contacts 14. Preferably the remote end segments of the antenna segments 18, 20 will remain uncoated; however, the entirety of the segments 18, 20 may be coated if desired.

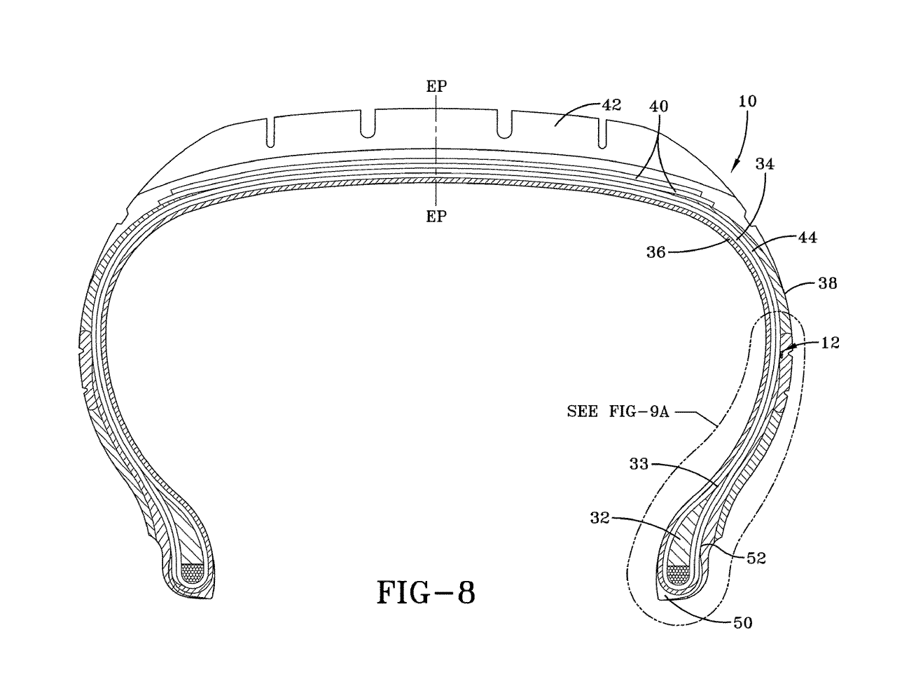

Referring to FIGS. 7A, 7B, 8, 9A, and 9B, the coated electronic device 12 is intended for incorporation into a tire 28 of generally conventional construction. The invention may be employed in tires suitable for any application. The tire 28 includes beads 30 and apexes 32 proximally situated above the beads 30. The apexes 32 constitute a rubber filler that is placed above the beads in an area within the tire where air could otherwise be trapped in its absence. Each of the apexes 32 terminates at a radially outward apex end 33. One or more tire plies 34 44; an innerliner 36; and sidewalls 38 are further added in the tire build. A belt package 40 is located beneath the tread 42 at the crown of the tire. The plies 34, 44 constitute layers of rubber-coated cord fabric extending from bead to bead and are turned up around the bead, thereby locking the bead into the assembly or carcass. The parallel cords 46 forming the tire plies may, pursuant to conventional tire construction, be twisted fiber or filament of polyester rayon, nylon, steel, or other material which gives the tire carcass and belts strength. In general, the parallel cords 46 extend from the bead to bead and reinforce the tire.

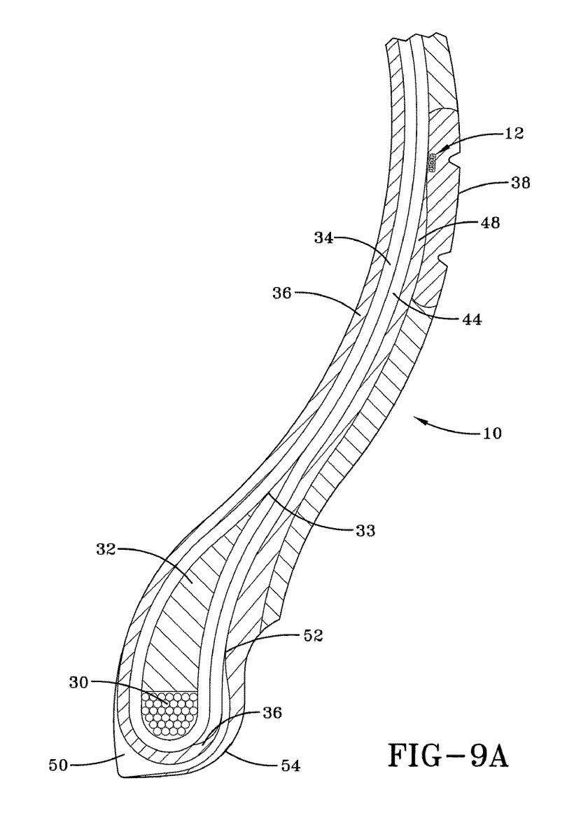

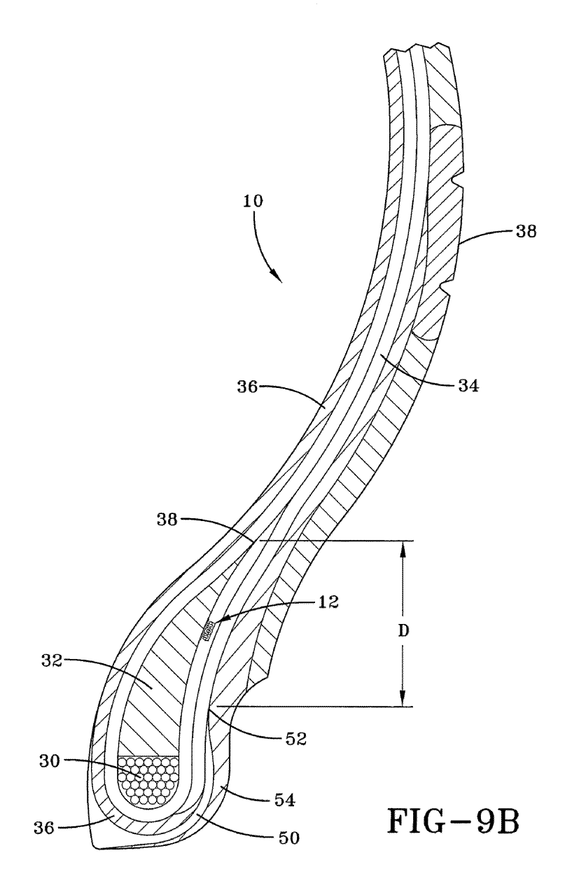

As will be appreciated from conventional tire build techniques, a green tire is constructed component by component. The beads 30 maintain the integrity of the green tire throughout the build process as layer ends are wrapped and turned up around the beads. The ply turnup 48 from the ply 44 wraps under the beads 30 as shown in FIGS. 7A and 9A. As explained, each apex 32 is positioned above a respective bead 30 and extends to apex end 33. A chafer component 50 is positioned during the tire build to the outside of the ply turnup and beads 30. The chafer 50 is formed of reinforcing material around the bead in the rim flange area to prevent chafing of the tire by the rim parts. The chafer extends to a chafer end 52. A rim cushion 54 is to the outside of the bead region and the outer tire component is a sidewall 38 extending to the tire tread.

The electronic device 12, subsequent to the coating operation shown in FIGS. 4-6, is preferably introduced into the tire during the green tire build operation. As shown in FIGS. 7A and 9A, the device 12 may be located at a sidewall location between the ply 44 and the sidewall 38. The device 12 is affixed to the ply layer by suitable known techniques such as the use of adhesive. The device 12 is oriented relative to the tire 28 such that the tag antenna 18, 20 extends perpendicular to the circumferentially extending ply layers. In particular, for steel reinforced ply tires, the tag antenna 18, 20 extends perpendicular to the ply cords. Embedding the device 12 in such an orientation utilizes the perpendicularly extending cords of the ply behind the device 12 to provide structural support and reinforcement. While the antenna 18, 20 in the device 12 is flexible, it is nonetheless desirable to limit the degree of flexure in the antenna to maintain the integrity of the antenna segments and their connection to the contacts 14 of the device 12. Orienting the antenna segments perpendicular to the ply cords thus minimizes flexure in the antenna 18, 20 during the life of the tire.

While the location of the tag assembly as shown in FIGS. 7A and 9A is advantageous in achieving a good reading from the tag by a remote reader, the sidewall of the tire is a high flexure region in a tire. The flexing that occurs in such a location may cause damage to the tag assembly 10 and the presence of the tag assembly 10 in such a location may tend to cause sidewall fatigue, damage, and/or separation. The tag assembly 10 may as a result have its integrity threatened by the harsh mechanical environment in the sidewall region.

Accordingly, the location of the electronic device 12 within the tire 28 may be moved to the position of FIGS. 7B and 9B. In this location, the device 12 is positioned in a region between the tire apex 32 and the sidewall 38. As with the tag position of FIGS. 7A and 9A, in the position of FIGS. 7B and 9B, the antenna is placed perpendicular to the ply cords and the longitudinal axis of the device is above the ply ending 48. It is preferred that the spacing between the axis of the device and the ply ending 48 be a minimum of 10 mm. It is further preferred although not necessary that the device 12 be located in the region between the chafer ending 52 and the apex ending 33. The distance “D” in FIG. 9B shows the region between the chafer ending and the apex ending. The device 12 is optimally embedded during the tire build operation. It is further preferred although not necessary that the device 12 be attached by suitable means such as adhesive directly to the apex. Affixation of the device 12 to the apex serves to protect the device from geometry changes associated with circumference changes from the building drum during tire build formation.

The location of FIGS. 7B and 9B is preferred although not necessary because the device 12 in such a location is positioned to provide good transmission to the remote reader while remaining protected from the mechanical service environment of the tire. The location against the apex and between apex and chafer endings will minimize the potential for sidewall fatigue, damage, and/or separation. So positioned, the device is further in a relatively stable and non-flexing region of the tire that will minimize the potential for tag damage or antenna malfunction.

From the foregoing, it will be appreciated that the invention satisfies the need for a tire and electronic device assembly that incorporates a device such as a UHF RFID tag into a tire in a manner that does not degrade the performance or durability of the tire, is mechanically suitable and durable in service, provides suitable radio frequency reading capability, and is capable of efficient incorporation into the tire manufacturing process. The tire and electronic device assembly includes a compound 24 having compatible permittivity and conductivity with the operation of a dipole antenna 18, 20. At least a portion of the dipole antenna is embedded within the compound. The device 12 is oriented to place a longitudinal axis of the dipole antenna 18, 20 perpendicular to cords 46 of a tire ply 44 in an uncured tire 28. The device 12 is preferably located between a tire apex 32 and a tire sidewall 38 of the uncured tire, at a predetermined distance “D” above an ending 48 of the tire ply. This preferred position of the device 12 is between a tire chafer ending and a tire apex ending at a distance of at least 10 mm from an edge of the ply turnup ending. It is further preferred that the device 12 be attached to the tire apex 32 to thereby benefit from the geometric stability of that tire region and to take advantage of the reinforcement and support provided by the apex. Partially encapsulated, such as shown in FIGS. 4-6, the antenna segments 18, 20 have remote end segments that project compound-free.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire and electronic device assembly, the tire having a pair of beads, at least one ply layer having a plurality of parallel cords extending from one bead to an opposite bead, the ply layer further having a ply ending wrapped around the one bead, an outer sidewall, an apex component positioned above the one bead and extending upward to an apex component end, and a chafer component wrapped around the one bead and extending upward to a chafer component end, the assembly comprising:
an electronic device including a transponder tag, a dipole antenna formed by first and second elongate antenna segments electrically coupled at inward ends to the transponder tag and extending in opposite respective directions from the transponder tag;
a compound having compatible permittivity and conductivity with operation of the dipole antenna, the transponder device and at least a portion of the dipole antenna being at least partially embedded within the compound;
the transponder tag being operably mounted to the tire in a position between the tire apex and the tire sidewall at a predetermined distance above an ending of the tire ply in an orientation placing a longitudinal axis of the dipole antenna perpendicular to the cords of the tire ply.

2. The assembly of claim 1, wherein the transponder tag is positioned between the tire chafer ending and the tire apex ending.

3. The assembly of claim 1, wherein the transponder tag is located above an ending of the tire ply at a distance of at least 10 mm.

4. The assembly of claim 1, wherein the transponder tag is mounted to the tire apex.

5. The assembly of claim 1, wherein the compound substantially encapsulates the transponder tag and the inward ends of the antenna segments; and each antenna segment includes a remote end segment extending compound-free.

6. The assembly of claim 1, wherein the transponder tag is positioned between the tire chafer ending and the tire apex ending in an axial tire direction at least a distance of 10 mm above the ending of the tire ply.

7. The assembly of claim 6, wherein the transponder tag is mounted to the tire apex.

8. The assembly of claim 7, wherein the antenna segments extend parallel with the tire apex ending.

9. The assembly of claim 8, wherein the antenna segments extend parallel with the ply ending.
